(19) United States
(12) Patent Application Publication
(10) Pub. No.: US 2015/0022662 A1
(43) Pub. Date: Jan. 22, 2015

(54) METHOD AND APPARATUS FOR AERIAL SURVEILLANCE

(71) Applicant: RAFAEL ADVANCED DEFENSE SYSTEMS LTD., Haifa (IL)

(72) Inventors: Israel Greenfeld, Kfar Vradim (IL); Zvi Yavin, Gilon-Misgav (IL)

(21) Appl. No.: 14/370,191

(22) PCT Filed: Jan. 1, 2013
(86) PCT No.: PCT/IL2013/050003

§ 371 Date: Jul. 1, 2014

(30) Foreign Application Priority Data
Jan. 9, 2012 (IL) 217432

(51) Int. Cl. G06T 7/20; G06K 9/00; H04N 7/18

(52) U.S. Cl. CPC G06T 7/20; H04N 7/181; G06K 9/00624; G06T 2207/10032; G06T 2207/30232
USPC 348/144

(57) ABSTRACT

The invention relates to a method of performing surveillance of an object moving on the ground, which comprises: a) providing two independent image-acquisition devices, wherein at least one of said devices is capable of acquiring high-resolution images, and the second of said devices is capable of acquiring low-resolution images; b) independently acquiring low-resolution and high-resolution images of the same scanned area; c) identifying an object the movement of which it is desired to follow, using the images; d) locating the object identified in at least one image; and e) following the movements of the identified object through a string of low-resolution images.

### FIELD OF THE INVENTION

The invention relates to the field of aerial surveillance. More particularly, the invention relates to a system and apparatus suitable for performing surveillance over wide areas, when large amounts of image data needs to be analyzed.

### BACKGROUND OF THE INVENTION

Arial surveillance has become of critical importance for security purposes, to locate, identify and understand security threats, and to trace those security threats back to their origin. Many efforts and money have gone into seeking solutions that would permit to monitor large areas for extended periods of time, such as in the “ARGUS-IS” project.

The ARGUS-IS, or the Autonomous Real-Time Ground Ubiquitous Surveillance Imaging System, is a Defense Advanced Research Projects Agency (DARPA) project contracted to BAE Systems. According to DARPA, the mission of the Autonomous Real-time Ground Ubiquitous Surveillance-Imaging System (ARGUS-IS) program is to provide military users a flexible and responsive capability to find, track and monitor events and activities of interest on a continuous basis in areas of interest in day time. The overall objective is to increase situational awareness and understanding enabling an ability to find and fix critical events in a large area in enough time to influence events. ARGUS-IS provides military users an “eyes-on” persistent wide area surveillance capability to support tactical users in a dynamic battle-space or urban environment. The three principal components of the ARGUS-IS are a 1.8 Gigapixels video Focal Plane array (FPA) plus two processing subsystems, one in the air and the other located on the ground. This system is architected around a single gimbal set (referred to hereinafter as: “head”) that moves and stabilizes a single Line Of Sight (LOS) having a symmetrical Field Of View (FOV). Unfortunately, in many cases the area to be monitored has a complex shape (for example when applied for border control) or few separated areas. Accordingly, a single LOS with pre-shaped FOV configuration results in an inefficient area coverage.

Furthermore, FPAs for night vision are much smaller due to technology limitations. Therefore night vision large FPA configuration will cover less area with less resolution.

While, in principle, systems of the type described above could provide at least a partial solution to the problem, they in fact generate a new problem that makes them difficult to exploit, inasmuch as the amount of processing and data communication needed to analyze high-resolution images is extremely high, requires extremely high computational powers and slows down processing, resulting in low performance. On the other hand, it is not possible to avoid using high-resolution images because of the need to clearly identify objects on the ground and relate them to potential threats.

It is therefore clear that it would be highly desirable to be able to overcome the aforementioned drawbacks and provide a system and method that would be capable of following the movements of an object or individual associated with a potential threat, while avoiding the need to apply too high computational power and while maintaining a performance of practical value for surveillance purposes.

There is therefore a need for a reconnaissance pod that can perform detection task as well as identification task of moving targets during day and night in a large area having a complex shape without resorting to large FPAs, large number of pixels and consequently complicated communication hardware.

It is an object of the present invention to provide such a system and method, which overcome the drawbacks and limitations of the prior art.

It is another object of the invention to provide a device useful for carrying out the method of invention.

Other objects and advantages of the invention will become apparent as the description proceeds.

### SUMMARY OF THE INVENTION

The present invention relates to a method of performing surveillance of an object moving on the ground, which comprises: a) providing two independent image-acquisition devices, wherein at least one of said devices is capable of acquiring high-resolution images, and the second of said devices is capable of acquiring low-resolution images; b) independently acquiring low-resolution and high-resolution images of the same scanned area; c) identifying an object the movement of which it is desired to follow, using the images; d) locating the object identified in at least one image; and e) following the movements of the identified object through a string of low-resolution images.

As will be apparent to the skilled person, in many practical applications high-resolution images will have a narrow field of view, and low-resolution images will have a wide field of view. However, the invention is not limited to such a situation and, for instance, high-resolution images may be acquired using a sensor having a wide FOV, since the FOV will be determined by the size and configuration of the sensor. Moreover, the terms “narrow” and “wide”, as applied to FOV in the context of the present invention, have a meaning relative to one another, rather than an absolute meaning. Accordingly, these terms are used herein for the sake of illustration, it being understood by the skilled person that this use is not intended to limit the invention in any way, such that, for example, given sufficiently powerful hardware and image processing power, it is possible to use high-resolution sensors also to acquire the relatively “low resolution” images of larger field of view.

The invention also allows acquiring high resolution images of the tracked object at every cycle of high resolution scanning, as will be explained in more detail below. Increasing the density of the sequential high resolution images enables tracking improvement and improved tracked object analysis.

According to an embodiment of the invention images are acquired using a “step and stare” process. In one embodiment the image-acquisition devices are located at two extremities of a single pod. In another embodiment the image-acquisition devices are separate devices. The image-acquisition devices may or may not possess a common axis.

In another embodiment of the invention one sensor (typically the low-resolution sensor) may not need to scan as if the area is small enough it can cover the whole monitored area by staring at it. In such a case, the low-resolution sensor will keep staring at essentially the same point while the high-resolution sensor scans the area. In such a case the staring sensor may acquire a stream of video rather than a string of separate images, although it may also choose to take individual images.

Further encompassed by the invention is a pod for carrying out reconnaissance and surveillance missions, characterized in that it comprises two sets of imaging devices each of which is independently actuated by a gimbals system.

In one embodiment of the invention the two sets of imaging devices are controlled by the same processing unit. The pod may comprise image processing means suitable to analyze images acquired by at least one of the imaging devices. It may further comprise communication means suitable to transmit data representing the images acquired by an imaging device.

The invention is also directed to a system for performing surveillance and reconnaissance, comprising two image-acquisition devices connected to an aircraft, wherein at least one of said image-acquisition devices is capable of acquiring high-resolution images, and the other is capable of acquiring low-resolution images, and a land station that receives and analyzes images acquired by said image-acquisition devices.

### BRIEF DESCRIPTION OF THE DRAWINGS

In the drawings:

FIG. 1 is a schematic description of the data acquisition and handling process;

FIG. 2 is a side view of a device (referred to throughout this specification as “pod”), according to one embodiment of the invention;

FIG. 3 is a prior art device described in US 7,126,726;

FIG. 4 is a rotated perspective view of the device of FIG. 2;

FIG. 5 is a view of the device of FIG. 2, with its outer cover partially removed; and

FIG. 6 is a schematic illustration of an exemplary image-acquiring procedure according to one embodiment of the invention.

### DETAILED DESCRIPTION OF THE INVENTION

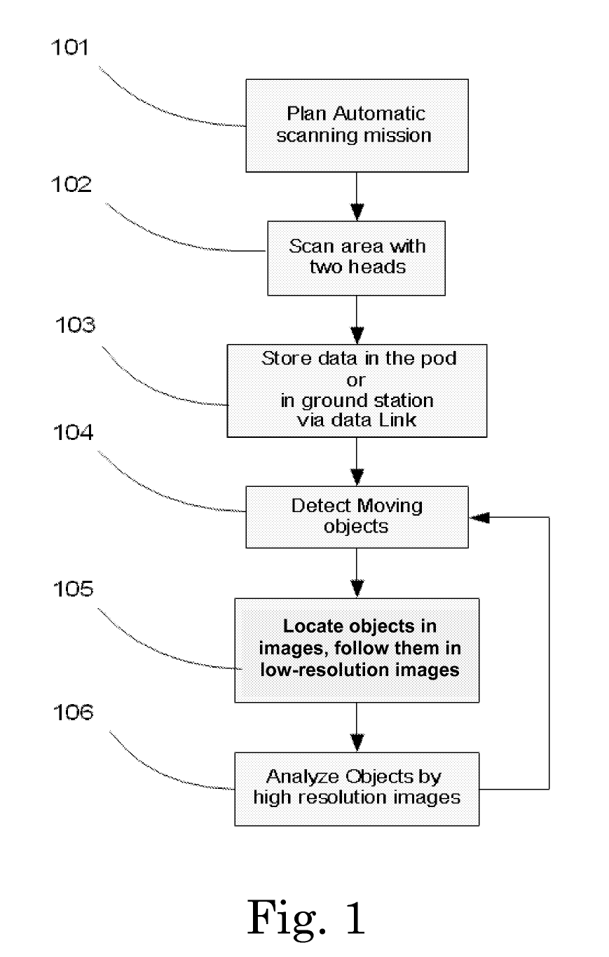

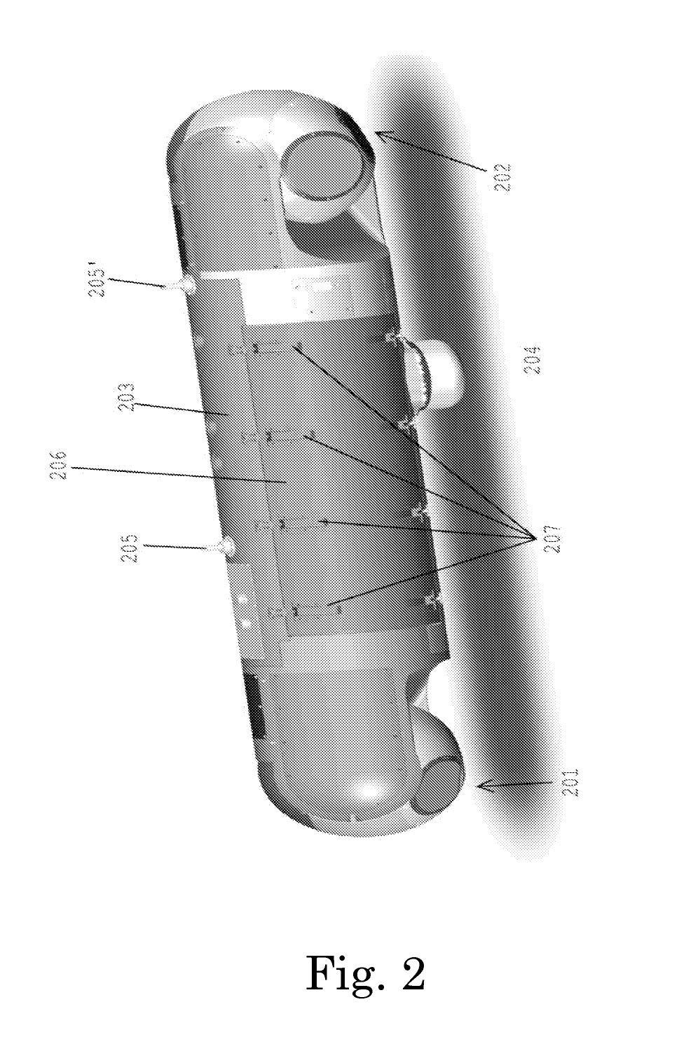

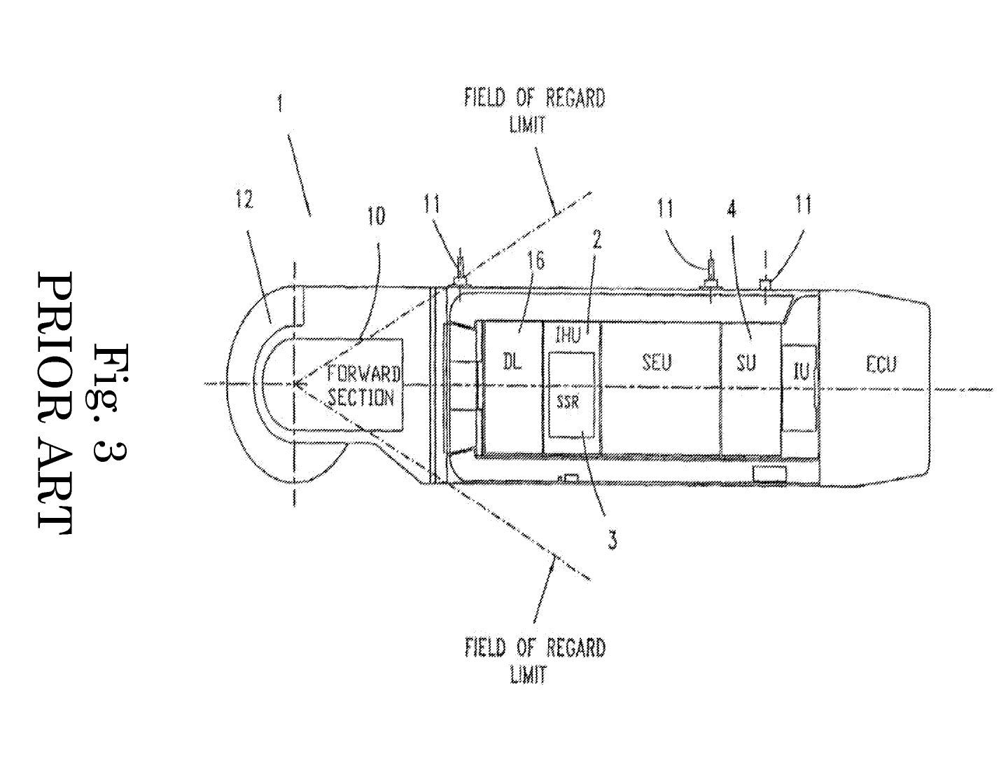

The invention will now be described with reference to a particular embodiment. Image acquisition can be effective, e.g., using the “step and stare” method described in U.S. Pat. No. 7,126,726, the description of which is incorporated herein by reference. The device according to this embodiment of the invention is pod 200 of FIG. 2. This pod is constructed on the basis of the pod described in U.S. Pat. No. 7,126,726 with reference to its FIG. 1, which is reproduced herein as FIG. 3. While the prior art device has a single optical “head”, mounted in its forward section, the device according to one embodiment of the invention has two gimbal-mounted heads 201 and 202, which are located at two extremities of tubular body 203, and together with it constitute the so-called “pod”. Other elements, such as antenna 204 and connectors 205 and 205′are known in the art, e.g. from U.S. Pat. No. 7,126,726, and therefore are not described herein in detail, for the sake of brevity. Also a hatch 206 is shown, which is closed by latches 207, and which is used to access internal parts of the pod. As will be apparent to the skilled person the tubular section 203 of the pod houses a variety of components, ranging from processing units, communication devices, mechanical elements and motors to drive the gimbals, optional cooling devices, etc. All those elements are understood by, and known to the skilled person and therefore they are not described herein in detail, for the sake of brevity.

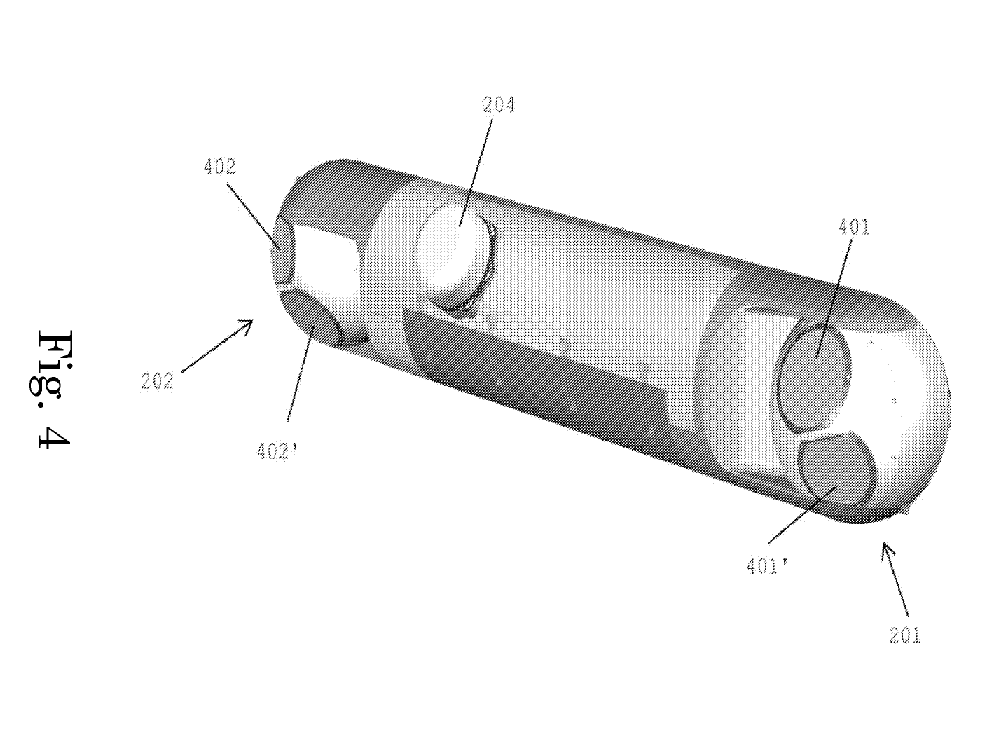

As can be seen from FIG. 4, more than one optical window can be provided in each optical head, e.g., to accommodate different types of imaging devices or for any other purpose. In the illustrative device of the figure each head has two optical windows, indicated by 401 and 401′, and by 402 and 402′.

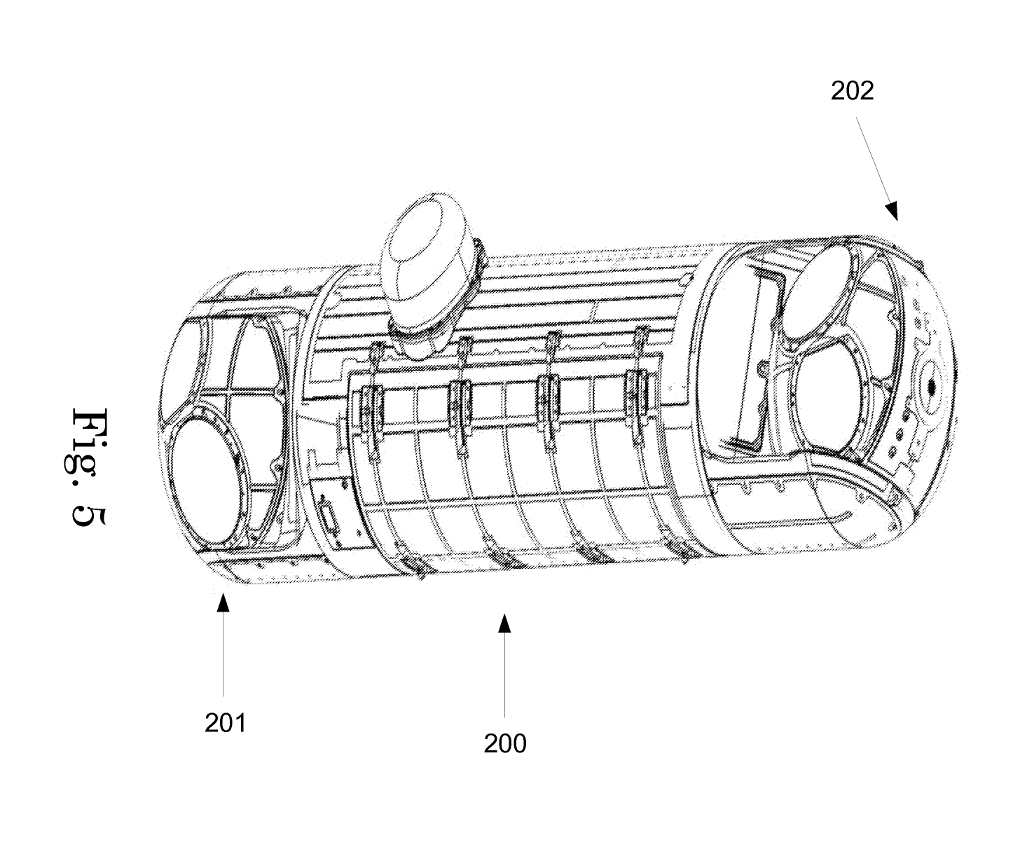

FIG. 5 shows the device of FIGS. 2 and 4 with some covering removed, to further illustrate the relationship of heads 201 and 202 to the remaining parts of the pod.

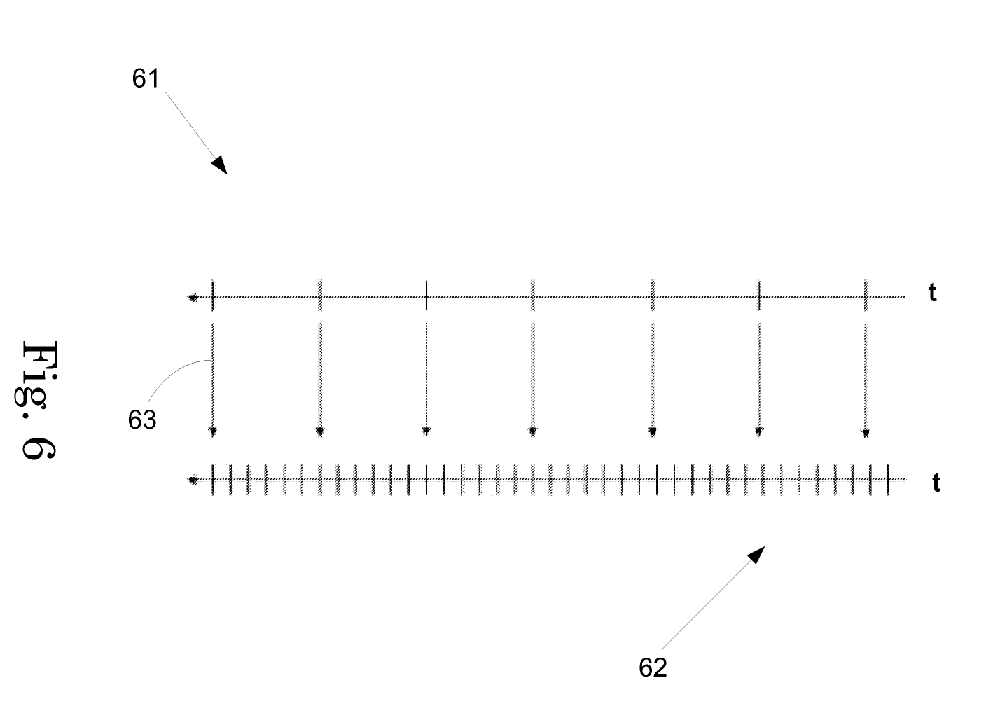

The following illustrative example will assist in better understanding the invention. Referring to FIG. 6, an image acquisition scheme according to one embodiment of the invention is schematically shown, which refers to a situation in which the acquiring aircraft is continuously circling above or in the proximity of the area that is being monitored, or in stand off, and acquiring images. FIG. 6 refers to one cycle of image acquisition. In the figure numeral 61 indicates the time axis for the acquisition of the high resolution images, and 62 that for the low resolution images.

As will be apparent to the skilled person, each image has metadata attached to it, such as the time the image was acquired and its GPS or other location information, which can be used to analyze an event that has taken place in the monitored area.

The size of the FPA is predetermined on the basis of engineering and availability considerations. The FPA can be used to image a large FOV thereby covering a large area. However, this comes at the expense of low resolution since the footprint of every pixel on the ground is large. On the other hand, using the FPA to image a narrow FOV enables a high resolution identification of objects at the expense of low area coverage. For instance, if the resolution rate between the low- and high-resolution sensors is 1:3, if they acquire images at the same rate (i.e., the same number of pictures is taken by both per second), the high-resolution sensor will complete a full imaging of the monitored area 9 times slower than the low-resolution sensor. In other words, by the time that the high-resolution sensor has acquired a complete high-resolution image of the area, the low-resolution sensor will have completed this task 9 times.

It is important to note that high and low resolutions are relative terms dictated by object size and details to be observed.

When operating using the pod described in the embodiment of FIGS. 2, 4, and 5 in most practical scenarios, one head scans a given area routinely using a Wide FOV, and the other head scans the same area using a Narrow FOV. This combination enables high scanning rates, using Wide FOV, on one hand, and simultaneously high resolution imagery of the same area (at lower rate), using Narrow FOV.

Referring now back to FIG. 1, the stages of the process according to an embodiment of the invention are schematically shown. Said stages comprise:

101—an automatic scanning mission is planned so the pod is able to scan the designated area, as described in U.S. Pat. No. 7,136,726, both for the head that is taking low resolution images and the one that is taking high-resolution images;

102—the aircraft on which the pod is mounted flies through the area to be scanned. Since the Wide FOV can cover the same area with much smaller number of frames, the pod scans the specified area continuously with low-resolution in high rate, and with high-resolution in lower rate. When the specified area can be covered by a single frame of the wide FOV (low resolution sensor), the line of sight of the wide FOV will obviously stare continuously on it, in which case step 102 will read “stare with wide FOV and scan with narrow FOV”, instead of “Scan area with two heads”.

103—data is sent from the acquisition, optical heads either to the pod itself or to a remote platform. Image processing algorithms can operate either in the pod itself, and thus provide near real-time results, or in a land station. A land station can perform image processing and analysis near real-time, after receiving the data from the pod via a communication line, or alternatively the whole image processing and analysis can be performed off-line after the scanning and image acquisition mission is completed. Which option to choose will depend on the specific requirements of a mission, as well as on the hardware made available to the pod;

104—the images are analyzed continuously in the mode that has been chosen;

105—a detected object is located in the low-resolution images. After the object is located its movement is traced in the high rate string of low-resolution images; and

106—the tracked object details are analyzed in the high resolution images.

The process of detection, tracking and analysis can be performed continuously in order to monitor any relevant event. Image processing and analysis can be performed in near real-time in the pod or by a land station after receiving the data from the pod via a communication line. Alternatively, the whole image processing and analysis can be performed off-line after the scanning and image acquisition mission is completed. Which option to choose will depend on the specific requirements of a mission, as well as on the hardware made available to the pod.

As will be apparent to the skilled person, although the double-headed pod described above is a most convenient, novel device for carrying out the invention, it is not necessary to provide imaging heads in the same device, and they can be physically separated into autonomous imaging devices or pods. Moreover, they don't need to be located on the same optical axis and one can be located, for instance, on a pod like the one of U.S. Pat. No. 7,136,726, and the other can be connected to the bottom of the aircraft. Appropriate use of the gimbals will provide for the correct orientation of the imaging sensors at all times.

It should also be emphasized that the above described double-headed pod presents additional advantages, inasmuch as it can be used for a variety of purposes. For instance, the device can be used to perform two separate scanning missions at the same time, as well as to allow two different operators to monitor two different areas or paths at the same time.

From the hardware point of view the two heads can be identical or different, inasmuch as an imaging sensor capable of acquiring high-resolution images can be operated at a lower resolution.

All the aforesaid description of a pod according to a preferred embodiment of the invention, as well as of a method to operate a surveillance system, have been provided for the purpose of illustration and are not intended to limit the invention in any way. Many different shapes, arrangements and constructions of the two image acquiring heads can be devised, and many different arrangements and communications between the image-acquisition devices and a remote land station can be provided as readily appreciated by persons skilled in the art, without exceeding the scope of the claims.

1. A method of performing aerial surveillance and reconnaissance of an object moving on the ground, comprising:
a) providing two independent airborne image-acquisition devices, wherein one of said devices is capable of acquiring high-resolution images, and the second of said devices is capable of acquiring low-resolution images at larger field of view;
b) independently acquiring by said two devices low-resolution and high-resolution images, by repeatedly scanning the same area of interest;
c) inspecting the acquired images, and identifying at least one object the movement of which it is desired to track;
d) locating each identified object in at least one image; and
e) tracking the movements of each identified object through a string of low-resolution images in which the object appears.

2. A method according to claim 1, wherein said images are acquired using a “step and stare” process.

3. A method according to claim 1, wherein the object the movement of which it is desired to track is identified using a high-resolution image.

4. A method according to claim 3, wherein the identified object is located in at least one low-resolution image.

5. A method according to claim 1, wherein the high-resolution images are acquired by scanning the area of interest, and the low-resolution images are acquired by staring at the area.

6. A method according to claim 1, wherein the image-acquisition devices are located at two extremities of a single airborne pod.

7. A method according to claim 1, wherein the image-acquisition devices are separate devices.

8. A method according to claim 1, wherein the image-acquisition devices do not possess a common axis.

9. An airborne pod for carrying out reconnaissance and surveillance missions, comprising two sets of imaging devices each of which is independently actuated by a gimbals system, and wherein the two image-acquisition devices are located at two extremities of the pod.

10. A pod according to claim 9, wherein the two sets of imaging devices are controlled by a same processing unit.

11. A pod according to claim 9, comprising image processing means suitable to analyze images acquired by at least one of said imaging devices.

12. A pod according to claim 9, comprising communication means suitable to transmit data representing the images acquired by an imaging device.

13. A method according to claim 1, wherein a land station receives and analyzes images acquired by said image-acquisition devices.

14. A method according to claim 1, wherein each of said image acquisition devices is independently actuated by a gimbals system.

15. A method according to claim 1, wherein the tracked object details are analyzed using the high resolution images.

16. A method according to claim 1, wherein the area of interest has a complex shape or a few separated areas.

17. A pod according to claim 9, wherein one of said devices is capable of acquiring high-resolution images, and the second of said devices is capable of acquiring low-resolution images at larger field of view.

18. A pod according to claim 9, wherein at the same time, each image acquisition device scans a different area of interest.

19. A pod according to claim 9, wherein the two image acquisition devices are identical.

20. A pod according to claim 9, wherein each image acquisition device can operate either at a low resolution or at a high resolution.

21. A pod according to claim 9, wherein an optical head at each extremity of the pod accommodates more than one image acquisition device, wherein said devices may be of different types.
